(19) United States
(12) Patent Application Publication
(10) Pub. No.: US 2022/0309465 A1
(43) Pub. Date: Sep. 29, 2022

(54) Integrated Space Sharing System Utilized Across One Platform and Methods of Use

(71) Applicant: Proximity Space, Inc., Montrose, CO (US)

(72) Inventors: Travis Scheidegger, Montrose, CO (US); Josh Hudnall, Grand Junction, CO (US); Nathan Brewer, Montrose, CO (US); Josh Freed, Ridgway, CO (US); Dennis Lankes, Montrose, CO (US); Brian Watson, Grand Junction, CO (US); Charles Johnston, Ouray, CO (US); Allison Blevins, Grand Junction, CO (US); Tracy Wesley, Grand Junction, CO (US); Geoff Oslund, Montrose, CO (US)

(21) Appl. No.: 17/616,893

(22) PCT Filed: Jun. 8, 2020
(86) PCT No.: PCT/US2020/036664

§ 371 Date: Dec. 6, 2021

Related U.S. Application Data
(60) Provisional application No. 62/857,909, filed on Jun. 6, 2019.

(51) Int. Cl. G06Q 10/10; G06Q 10/06; G06Q 10/02

(52) U.S. Cl. CPC G06Q 10/103; G06Q 10/06315; G06Q 10/101; G06Q 10/02

(57) ABSTRACT

The present invention relates to a system and method for integrating various reservation, scheduling, access and payment functions into one platform for ease of utilization of shared coworking spaces, generally, and to a system of informing an individual of a shared space location, allowing an individual to locate shared space availability, credentialing a user for shared space access, allowing an individual to submit payment for a shared space and, correspondingly, permitting a manger to receive appointments and payments via an integrated connection of user, space and space manager and associated calculated perimeters, specifically.

### BACKGROUND

### Field of the Invention

The present invention is directed, generally, toward a platform, system and method for integrating various member (consumer and operator) management, inventory management, resource reservation, access control, billing, payment, reporting and social networking functions into a single, integrated platform for managing and using flexible spaces. More specifically, the platform, system and method for integrating various functions enables operators of flexible spaces—often, but not limited to coworking spaces—to easily monitor, manage and facilitate the use of their space by members, and creates an easy way for members to utilize the facilities and services offered by the flexible workspace. Further, proprietary hardware is integrated into the platform to control physical access through doors, gates, and/or other ingress and egress methods.

### Background of the Invention

Coworking and coworking spaces provide for a communal, economical use of an apportioned space and shared equipment and utilities. Yet, coworking itself is more than the physical division of a work space and finds its primary attractiveness, among independent contractors, telecommuters and travelers, alike, through the establishment of a coworking “society” or cooperative “community” in which space is utilized economically and with the greatest utility.

Finding its roots in the early 2000s, coworking originated as a means to maximize the usefulness of a space without undertaking long term lease commitments, incurring related permanent occupancy expenses and requirements of continued and continual residence. Yet, coworking spaces provide more than simply cost efficient use of a space and advantages can manifest themselves in a myriad of gains including networking, collaboration, increased productivity and efficiency and, in most cases, access to amenities that wouldn't otherwise be unavailable to consumers without a permanent work space.

Yet, even with all the advantages above, coworking itself can prove operationally cumbersome for both office space seekers and space managers. Manifestly, the information gap existing between consumers and operators, in terms of space procurement and efficient utilization of space, is wide and is riddled with inefficiencies—often resulting in space underutilization and waste. Adding to this wastefulness is a non-ergonomic exchange between users and operators, resulting in frustration and irritation at the space procuring process. Compounding this issue is the need for the physical presence of a manager or operator of a space for the coworker to access the space and facilities.

Thus there is a significant, well recognized, and yet unmet need in the art for a single platform, system and method for integrating both software and hardware into one design served by a single software application, either mobile or internet website based, effectively marrying an individual's desire to locate, schedule, purchase and access a space and a space manager's need to offer, advertise, make accessible and collect payment for specific spaces on a property without having to physically occupy that space. Too, it is desirable to streamline the transfer of monies between parties in a paperless, uniform transaction.

It is the goal of the present invention and method of use to remedy shortcomings in the art through a simplified platform that allows consumers and operators to more effectively communicate and achieve their respective goals where consumers may browse, locate, reserve and purchase allotted space and space owners and managers are offered lower logistical hurdles to space advertising, letting and payment.

It is a further defined goal of this invention, system and method of use to promote and potentiate the efficient use of coworking spaces, decrease the information gap between consumers and space operators, facilitate the interactions between principals, decrease operational costs, increase property revenues and aid in the subscription services to members and time commitments and reimbursements to operators.

It is another goal of the invention to provide an integrated system, network, and method for collecting, indexing, categorizing, and making discoverable to individuals, businesses, and groups information about flexible spaces, location-flexible workers, companies, jobs, and events. This enables users to find resources that can enhance a shared-space experience and foster success in their businesses and personal lives.

It is yet another goal of this invention to provide an integrated system, platform, and method for managing invoicing, payment transactions, vendor payouts, taxes, cleaning fees, and fees for use and/or access to the various components of the system and/or the resources managed by the various operators of the system. This system enables a user to submit a single payment that can be used to pay for products or services from one or more operators and vendors, simplifying the transacting of commerce between many discreet parties.

And while inventors have set forth the best mode or modes contemplated of carrying out the invention known to inventors such to enable a person skilled in the art to practice the present invention, as well as the method of use, the preferred embodiments are, however, not intended to be limiting, but, on the contrary, are included in a non-limiting sense apt to alterations and modifications within the scope and spirit of the disclosure, diagrams and appended claims.

### SUMMARY OF THE INVENTION

The present invention evidences a useful, novel and unobvious integrated platform and system for the discovery, management, and utilization of coworking spaces, office spaces, executive office suites, meeting rooms, event spaces, and other flexible spaces through a subscription-based platform where users receive credentials enabling them access to various parts of the system based on their subscription and credentialed permissions.

For the space provider, the current invention allows for providers to allot space on a time and location basis, both locally and globally, for reservation on minute-by-minute, hourly, and monthly basis—and all multiples and subdivisions therein. Particular spaces can be reserved, allotted, and paid for by consumers based on the space's set parameters of price, availability, access, privileges, and terms.

For the consumer, the present invention provides a platform to research spaces, discover spaces with availability for reservation and/or associated services offered at specific locales wherein the current platform provides a conduit to discover and reserve space immediately and/or in the future via a subscription purchased by the consumer. Alternatively, the consumer is able to purchase spaces a la carte or the consumer may be “gifted” an allotment by a platform member. Too, multiple subscriptions at one to a plurality of spaces across the network may be purchased for use by one or more users, billed to specific users, or a single user, via multiple or a consolidated invoice or invoices, respectfully.

The present invention platforms, systems and methods are constructed as a single platform (and/or a group of connected or assimilated platforms) designed to integrate hardware and software into one system that seamlessly enables providers to advertise, commercialize and operate available space locally, regionally, domestically, and abroad. For the space provider the present invention allows the provider (1) to advertise a space, (2) to offer specific time-based and permission-based schedules, (3) to set parameters for access and privileges based on subscription levels, (4) to allow access to designated space or spaces for members according to the schedules and parameters set, and (5) to designate and collect costs, fees, and taxes for use of reserved space or services. For consumers the present invention allows an individual (1) to locate a space, (2) to reserve time in that space, (3) to access that space via “Open” physical access control (based on subscription type and subscription status), and (4) to purchase, pay for, and/or extend allotted time in that space. For a third-party searching, reserving and/or purchasing on behalf of a consumer, such as the manager or coordinator of a team, the present invention, system and method of use allows (1) for the purchase of one subscription, to a multiple of subscriptions, at one or more spaces in the network, (2) for the purchase of reservable resources by the multiple, managed consumers according to budgets set by the manager across at one or more spaces, and (3) for consolidated, regular billing on monthly intervals on a single invoice or multiple invoices.

The granting and termination of access and privileges to a certain space is directly related to and controlled by changes in the subscription level, subscription status, and the schedules and privileges associated with said level at each space. Access is controlled through an integrated, proprietary hardware component, designed to remotely access and operate standard, commercially available locking mechanisms such as magnetic locks and/or electronic strikes, obviating the need for traditional “keyed” access (see “Open” below). The subscription level thus affords space access that is initiated and accomplished through a software application that, once credentialed, allows for authorized access to specifically designated areas as well as certain control functions within that area.

Succinctly, the present invention is a platform and system providing for a network that offers a provider-generated nexus or “connected, collaborative network” whereby the provider is able to list space availability for reservation on a time and permission basis as well as associated products and services and a consumer is afforded a means to locate, reserve, purchase and access listed flexible spaces and associated products and services. Put another way, the present invention facilitates both of these principals by providing a platform capable of ingesting, indexing, searching, calculating, manipulating, acting on, and making available the data, settings, parameters and physical controls necessary to enable these functions.

The integration of the many discreet software and hardware components is key to the overall functionality of the present invention in that the software enables configuration of software parameters and physical activation of hardware devices, through mobile-based or computer-based applications, to remove the physical barriers to entry, permitting consumers to access and utilize areas based on their subscription type and subscription status, combined with access schedules and privileges associated with subscription. The activation of a subscription, either by request of the consumer (user) or action of the provider gives the consumer access to a space and/or the utilization of associated products and services within a space. Conversely, the cancellation of a subscription, either by expiration, request of the consumer or by action of the provider, automatically removes the consumer's ability to access the space and/or utilize associated products and services.

The current invention is composed of many integral and symbiotic parts and features enabling the functional use of a space. Integrated software applications (e.g. see “Room View” below) may be used where a programmable or updatable mobile device and/or tablet computer (connected to the system through Bluetooth®, Wi-Fi and/or other wired and wireless connection mechanisms) can serve to enable the retrieval or configuration of information and activation of features available through the system. Tablet computers can act as digital signage, providing wayfinding, scheduling and other information related to the space, and can additionally be used to create, extend and/or terminate reservations from a quick-access interface. Mobile devices can utilize proprietary applications to interact with the space based on previously described subscription levels and statuses, including the ability to unlock physical doors, create and cancel reservations, browse space information and even search the network for more spaces to reserve.

In some embodiments, physical locks may be activated, deactivated, and made to engage and disengage any number of functional operations ranging from (1) physical operations: exterior and interior doors operations and garage door operations to (2) utilities operations: lawn (water) operations, temperature operations, lighting operations, dispensing operations (e.g., coffee, soda or alcoholic beverages). In such embodiments, providers of a designated space may pre-program or regulate the overall functioning of a space remotely without the need for direct intervention or on-site presence. Further, operators and managers can monitor and regulate operational activities for security, control and billing purposes.

In some embodiments, a computer, stationary or mobile, can be made to communicate (through direct scan, Bluetooth®, or Wi-Fi and the like), with the system via a computer server to open closed areas, close open areas, operate utilities and/or otherwise control various physical aspects of the accessed space.

As a basis for understanding, the following excerpts may be used to more fully understand the individual components, inputs and operational aspects that make up the present invention (in addition to appended materials). These excerpts are not meant to be a comprehensive view of every feature of the invention nor exhaustive and are provided by way of example. Modifications, additions and subtracts may be made to the following design without departing from the spirit of the invention and may be undertaken to suit the needs of the space, consumer, operator or a combination thereof.

### Network

The network is the template by which all the functions and functionalities are accomplished vis-a-vis the various features of the present invention. The network itself is made up of three basic components: (1) all spaces (however divided, subdivided or undivided) in aggregate (2) all participating providers connected to and participating in the network and (3) all consumers (i.e. members/users) connected to and participating in the network. All spaces, providers and consumers are therefore supported by the system, network and method of operation and each feature of the present invention fosters efficient use of spaces and interactions between components (i.e. resources and utilities) and participants.

Being a part of the network enables space operators to access and utilize the present invention to effectively control, manage, market and sell access to their respective space(s), while consumers are allowed to research, locate and purchase access to certain spaces, or areas within spaces, select services within spaces or a combination thereof.

The network itself is designed and built to facilitate multiple types of connections existing between each of the three primary components (space, consumer and provider) creating a nexus where communication avenues include the following: (1) space-to-space, space-to-consumer, space-to-provider, consumer-to-space, consumer-to-consumer, consumer-to-provider, provider-to-space, provider-to-consumer, provider-to-provider or a combination thereof.

### Platform and Operator

The current invention consists of the aforementioned network, consisting of spaces, consumers and providers, which are integrated and interdependent upon one another for the proper functioning of each in relation to the other. The coexistence of all of the three primary components is supported by a computer platform by which the function of a computer software is executed providing for a seamless connection between consumer initiated actions (via application programming interfaces (API)) where computer programs affect changes in real-world hardware (i.e. locks, utilities and related functionality and services). The platform itself is operated and controlled by the platform operator which is responsible for maintaining the interconnectivity of spaces, consumers and operators.

### Inventory Management

In addition to affecting mechanical actions through hardware effectuation, the platform described supra constitutes a system which is capable of capturing, tracking, managing and selling real estate inventory on a per-seat basis. Managers and building owners can input rentable and reservable spaces, organized by campus, building, floor, area, seats etc., with size dimensions, photos, descriptions, amenities and pricing information. Individual seats can be assigned to individual consumers or placed into a pool of “hot seats” that are available on a first come, first served basis. This information is utilized as the central repository for a building's available inventory, providing coworking spaces, managers and building owners with a way to track, manage and sell memberships and real estate leases down to the individual level. This information powers a centralized marketplace, where individuals and businesses looking for flexible workspace can browse much of the open inventory within a city, region, and beyond based on availability, location and price. Proprietary algorithms filter and display the most relevant results to users searching for workspace and a billing engine powers the application to also control transactions within this inventory management system. Purchasers make one payment each month for the total of all inventory they are reserving. The various owners of any inventory reserved receive payouts for their inventory reserved. All income is paid to the network and platform operator and all payouts are paid from the network and platform operator, the system executes and tracks these transactions automatically in a seamless experience for both the supply (operator) and (consumer) demand side. The system is capable of tracking and managing marketing, booking, transactional and other fees associated with the listing and or reservation of spaces.

### Hardware/Software Interface

Custom 100×100 mm 1.6 mm 2 oz copper laminated PCB. Board design incorporates modular plugs for door and relay accessories, power, contact sensors, and a keypad in the form of a custom 100×100 mm 1.6 mm 2 oz copper laminated PCB (printed circuit board). Operations for Relay and Keypad are controlled by ATmega32U4 AVR chip, which also connects to an independent Real Time Clock with lithium coin battery backup. Door contacts utilize optocouplers to isolate and protect the board. Relay output utilizes mini-blade automotive style fuses. These fuses protect the board from providing too much power draw to a channel, but also serve as a convenient way to remove power from the channel and leverage it as a dry contact. Higher level operations which directly interact with our IoT platform are executed on the MediaTek 7688. Also, in charge of routing messages to the lower level microprocessor and managing firmware updates for both the ATmega32U4 and itself (MediaTek 7688 SOC).

### Open

“Open” is a system composed of communicating software applications to hardware activation via relays that initiates and enables the control (i.e. activating/opening and closing/locking) of magnetic locks, electronic strikes, valves, machinery, gates, motors, thermostats, flow meters, circuits and other physical devices through the present platform. Within this communication, the space exhibits various locks, controls, or a combination thereof, for space entrance and egress.

The ‘Open’ function, in one preferred embodiment, consists of 4 onboard relays which may be expandable to up to 255 onboard relays, using expansion boards, whereby relays are installable at various locations about individual spaces to perform area-specific functions within a space. Furthermore, relays themselves are customizable and programmable within individual spaces and may be designed to function and operate either independently or in concert with other relays relative to each other and may be used to convey information bi-directionally with an established network via an Ethernet, wired LAN connection or, in the alternative, wireless technologies (e.g. Bluetooth® and Wi-Fi®).

By way of example, users may rely on several means of door access, each founded upon and relying on access to the network. Ideally, the user may, after gaining access to the present software application through proper authorization and credentialing, use the present computer software application to open door via a website, mobile computer application, a platform provided PIN code, and/or any provided key fob (through onsite authorization to access said key fob).

As referenced above, magnetic locks, using one of the available relays, may be pre-programmed or remotely instructed to both lock and unlock on a timed schedule or upon the occurrence of a particularized event. Programmable inputs may be used to monitor the state and configuration (e.g. locked or unlocked) of door locks and provide status of the state of door locks through programmable inputs via scheduled updates, actively through queries, or a combination thereof, of the state of said relays.

And while allowing space access through door and door lock activation and deactivation on a schedule is certainly a feature of the present invention, it is the immediate access to a space by a user that provides (through magnetic locks, strike locks or both) the most utility in terms of usefulness. Namely, it is access granted to a user, either through a reservation or an immediate query for access, by the user of the present system through a software application allowing permitted user access and ‘Open’ durations of 100 ms-1 hr (based on user access schedule and reservations) wherein toggled lock and/or unlock user action (based on user access schedule) may be entitled and terminated through custom proprietary script logic, MQTT (Message Queuing Telemetry Transport), IoT (Internet of Things) or a combination thereof.

Additionally, the same technology may be garnered to control other applications that have additive and complementary advantages to remotely or programmable control space maintenance, space utilities and space resources access. Included among these is (1) control of water valves in garden or lawn maintenance (using one to a plurality of relays with an integrated analog input) where said valves may be scheduled to activate and deactivate on a set schedule, function of the valve may be toggled ‘on’ and ‘off’ through a user's direction and action manually, durations could span from milliseconds to hours, soil moisture may be monitored with a separate analog sensor or sensors and, as above, actions may be controlled through interactions with proprietary script logic, MQTT (Message Queuing Telemetry Transport), IoT (Internet of Things) or a combination thereof.

Equally, parking garage access may be controlled via the same or similar technology wherein set periods of garage access may either be scheduled based on a time of accessibility or may be immediately accessible to an authorized user, acting within a scheduled reservation period, or with proper validation or may be remotely accessible to initiate immediate access by an operator or manager of the property. And, garage parking access state may be also monitored using the same or similar technology whereby the state could inform the property owner or manager of gross information (open/closed state), occupancy state (with the appropriate number of sensors)—all the way down to an individual parking bay's occupancy by a user or other. Again, these actions may be controlled locally or remotely through either user authorized activation or remote activation utilizing interactions with proprietary script logic, MQTT (Message Queuing Telemetry Transport), IoT (Internet of Things) or a combination thereof.

It is further within the contemplation of inventors to control various other functions with proprietary script logic, MQTT (Message Queuing Telemetry Transport), IoT (Internet of Things) within a space including (a) a DC motor control where scheduled motor activities could include forward, reverse and stop and permitted users actions may be accomplished within a revered time period, (b) a flow meter/beer keg tap/soda machines (and related inventory) may be scheduled to allow or disallow access and monitored, logged and billed by operators to user's accounts based on reserved time slots ranging from milliseconds to hours, (c) thermostat and lighting controls may be scheduled or remotely activated, adjusted and deactivated to correspond to occupancy and according to designated zones and/or (d) combined with any RS485 (high speed serial data communications) or Z wave (SoC in the 900 MHz range) enabled devices.

### Billing Engine

At the core of the invention is a bespoke and comprehensive billing system capable of generating invoices, collecting payments, retrying failed payments, automated recurring billing or a combination thereof. This billing engine is agnostic of payment processor and is capable of being used with one or more payment processors simultaneously. A unique feature of this engine is the ability to take in multiple payments from multiple consumers and distribute payouts to multiple providers based on space utilized, time of utilization and services used, enabling a new class of reservation management and ease of use.

Key Features of the ‘Billing Engine’ include the ability to accept payments from consumers in countries around the world and, reciprocally, the ability to generate payouts to providers internationally as well. Moreover, scheduling is available for handling recurring payments in addition to initiation and receipt of one-time payments. Too, discounts can be applied across invoices, taxes can be added to user's invoices and taxes can be managed for operators, owners and managers for a given space.

To the benefit of both users and operators, the ‘Billing Engine’ can track multiple payment methods and preferred payment methods per user per space, can automatically retry failed recurring payments (reducing “churn”), handle voids and refunds across multiple users and operator/manager/owners and manages the transaction and processing fees associated with taking payments

### Memberships

Consumers may function within the current system in one of two ways: (1) through subscription or (2) ala carte. In the former, consumers interact with spaces and within spaces as “members” who subscribe for a position on the platform. Memberships are subscriptions that enable access and grant privileges to a space or areas of a space based on certain membership levels wherein consumers may be members of one or more spaces within the network. Alternatively, as in the later, consumers may seek to access individual sites or spaces sporadically wherein purchasing a space is occasional or infrequent and where an avenue is supplied to the consumer to purchase a single space or spaces within one window of time to a plurality of times in one transaction. As would be expected, a higher premium is placed on the space and time for a single transaction as opposed to an ongoing membership. Further, spaces and times can be subject to ranges of rates where a space and time that is considered peak would exhibit higher cost than the same space and time that is considered off-peak.

### Reservable Resources

Reservable resources are tangible resources (e.g. conference rooms, office equipment, computers, phone booths, and machines) and services (e.g. childcare, pet care, consumables, Wi-Fi®) requiring availability, scheduling and, in most instances, advance notice and payment. As with particular space availability and discrete time reservations, reservable resources are subject to site-specific availability and up to the discretion of the space operator as to whether or not these reservable resources would be offered and by which parameters their offering would be subject to. Conceivably, resources can range to be reserved on a minute-by-minute or hourly basis according to parameters defined by the space operator where reservations can, at the discretion of the space operator, provide temporary access to areas, doors, amenities, resources, Wi-Fi and the like.

### Profiles

Profiles are a user's identity on the network. All users have a profile that can be made public or private, and includes a range from basic information about the user (first name and last initial) all the way up to more specific identifiers including: first and last name, birthday, biographical information, contact information, social media links, skills and abilities, employment history and more.

### Employment, Events Listings and Company Listings

Inventors envision a space on the platform for providing a directory of jobs within spaces or for the platform itself, events hosted by operators, consumers or the platform, or a combination thereof, available to current members of and operators on the network in order to provide a virtual message board informing principals (consumers, space providers and other platform participants) of both job opportunities and events between and among consumers and providers and between and among the platform operator and consumers and operators.

Further, the platform operator has the ability to provide a directory of companies associated with or operating within spaces in the network or on the platform that may opt-in, or be contractually bound, to inclusion into a company list or company directory whereby members are allowed access to these directories in order to be informed of services or employment opportunities through vendors or other third-party operators.

### Cisco Meraki Integration

The current embodiment of the platform integrates with the Cisco Meraki API interface to enable automations for spaces such as automatic Wi-Fi guest networks, virtually instant granting and denial of access to network services based on subscription level and subscription status, although other interfaces are contemplated and may be interchanged within the current platform without changing its overall functionality. Advantageously, though, this particular integration can enhance security by leveraging Meraki Group Policies to isolate users from other users on a network by allowing the platform operator to utilize the existing template to allow an admin to set custom limits for certain devices or users, for allowing full access, denying a client or an intermediate stage within the two.

### Nomad

The ‘Nomad’ feature of the present invention provides a directory of participating space providers enabling consumers to search for, find and reserve time at spaces internationally. ‘Nomad’ allows for membership wherein members purchase credits which can be used to reserve access to a space or a plurality of spaces abroad. Upon utilization access, the space is paid an amount set by the space provider, taking into account exchange rates, and a proportional amount of credits are deducted from the consumer's account.

### Team

The ‘Team’ feature of the present invention provides a tool and interface for the management of multiple subscriptions and multiple users across multiple spaces. This is especially helpful for corporate and large scale membership where, although the subscription levels, spaces and times may differ, the billing for a “team” or group of individual members is consolidated into one monthly invoice where the payer does not necessarily have to be a member of any space.

### Guest Pass

The ‘Guest Pass’ feature of the present invention enables members of any participating space in the ‘Network’ to visit other participating spaces up to a certain limit (e.g. three times per month) without incurring additional charges. This reciprocal agreement between spaces is one of the unique, defining characteristics of the current invention and ‘Network’ wherein each space provider may “opt in” to a mutual arrangement that spans the entire network as to increase the options of certain members and the flexibility of certain operators, at each's discretion.

### Room View

‘Room View’ is a novel, proprietary software application for tablet computers (e.g. iPads® and other tablet mobile computers) that acts as digital signage and a control center for space reservations and reservable resources within a space. ‘Room View’ operates in one of two modes, interior or exterior, at the discretion and option of the space provider. ‘Room View’ can exist singly or in combination with a plurality of “Room Views”, all operating simultaneously and working together to provide a more comprehensive view of available space, times, site-specific resources, or a combination thereof, and provide greater control and facilitated access thereof.

When in interior mode, ‘Room View’ provides a visual cue of the current reservation of the resource, how much time is left on the reservation, information about guest Wi-Fi access, when available, and provides the ability to check-in for, extend or end a reservation, among other conceivable information displaying functions. ‘Room View’ set to interior mode also provides visual and audible cues when a reservation is commencing and coming to an end as well as an indication as to time remaining.

When in exterior mode, ‘Room View’ acts as interactive digital signage, displaying the current and upcoming reservations in font and type sizes designed to be read at a distance. In this mode users can create quick, reservations and check into existing reservations. Users can also access schedules, times, availability and cost of upcoming and potential reservations.

### Wave

‘Wave’ is a fully integrated digital concierge service capable of augmenting or replacing the functions of a basic front desk attendant. ‘Wave’ is available on any device with a modern web browser and enables guests and members of a space to take actions such as requesting a tour, notifying other members of their arrival and notifying members of deliveries such as guests, food or packages. Additionally, ‘Wave’ allows guests to sign up for mailing lists and allows members to ‘check in’ as present at the space. ‘Wave’ is an additional complementary feature which allows for operators, owners and managers to remain off-site and to supplement or supplant the duties of a receptionist or concierge.

### BRIEF DESCRIPTION OF THE DRAWINGS

While the novel features and method of use of the application are set forth above, the application itself, as well as a preferred mode and method of use, and advantages thereof, will best be understood by referencing to the following detailed description when read in conjunction with the accompanying drawings in view of the appended claims, wherein:

FIG. 1 is a block diagram depicting the ‘Get Keys Flow’ for authorizing a virtual key for space access.

FIG. 2 is a flowchart illustrating the ‘Unlock Door Flow’ for space access by a user.

FIG. 3 is a block diagram illustrating ‘Login Flow’ for user interface into the present system.

FIG. 4 is a flow diagram depicting “Subscription Flow” for a member's access to the present system

FIG. 5 represents a flowchart for ‘Reservation Flow’ for reserving a designated space.

FIG. 6 illustrates the block diagram ‘Internet Access Flow’ for members to access an internet connection.

FIG. 7 displays the flowchart for the ‘Recurring Billing Flow’ for member billing.

FIG. 8 depicts a block diagram of the present invention's integrated network.

FIG. 9 illustrates a block diagram of the ‘Door Controller Integration’ as it relates to external interfaces, door controller and platform

FIG. 10 is a representation of the user interface (i.e. mobile computer device) which is encountered by the user when accessing the platform that is the current system.

FIG. 11 depicts a unified billing and payout flow diagram depicting consolidated billing and Individualized payouts.

FIG. 12 illustrates inventory organization from company down to individual seats.

FIG. 13 is an open controller.

FIG. 14 is a representation of an initial authentication.

FIG. 15 illustrates an authentication user.

FIG. 16 depicts the core application structure.

### DETAILED DESCRIPTION

A detailed description of the preferred embodiments of the invention is disclosed and described below. Yet, each and every possible feature, within the limits of the specification, are not disclosed as various permutations are postulated to be in the purview and contemplation of those having skill in the art. It is therefore possible for those having skill in the art to practice the disclosed invention while observing that certain placements and spatial arrangements are relative and capable of being arranged and rearranged at various points about the present invention that nonetheless accomplishes the stated advantages and/or correction of one or more of the infirmities outlined and discussed above.

Equally, it should be observed that the present invention can be understood, in terms of both design and function, from the accompanying disclosure and claims taken with reference to the associated drawings. And whereas the present invention and method of use are capable of several different embodiments, which can be arranged and rearranged into several configurations, without departing from the scope and spirit of the present application as shown and described.

### Get Keys Flow

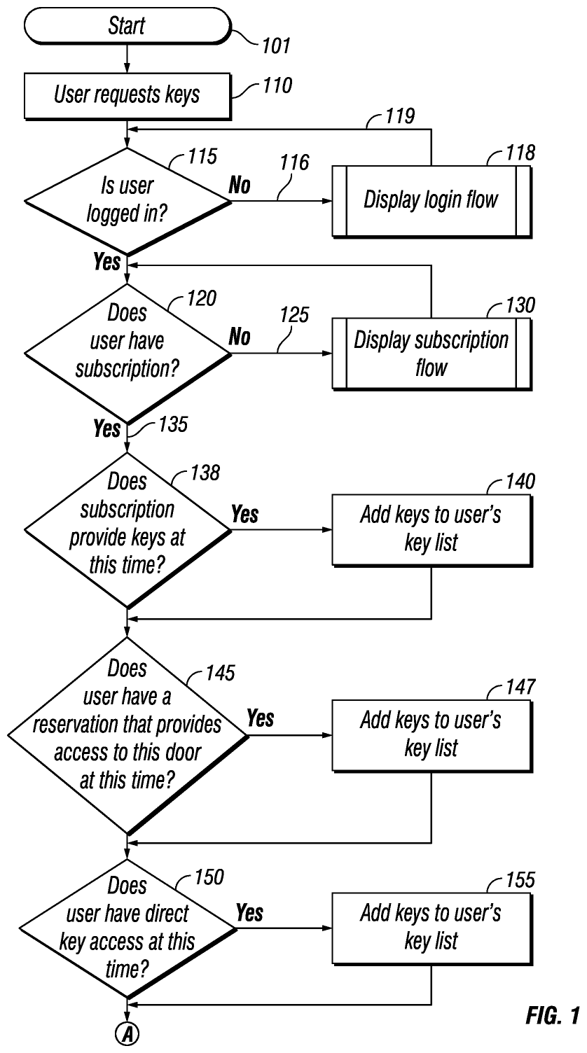

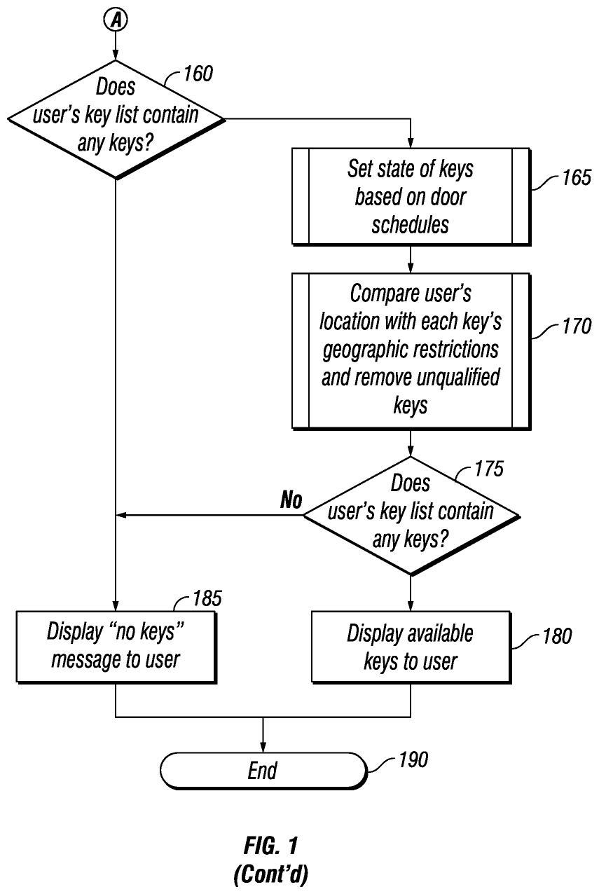

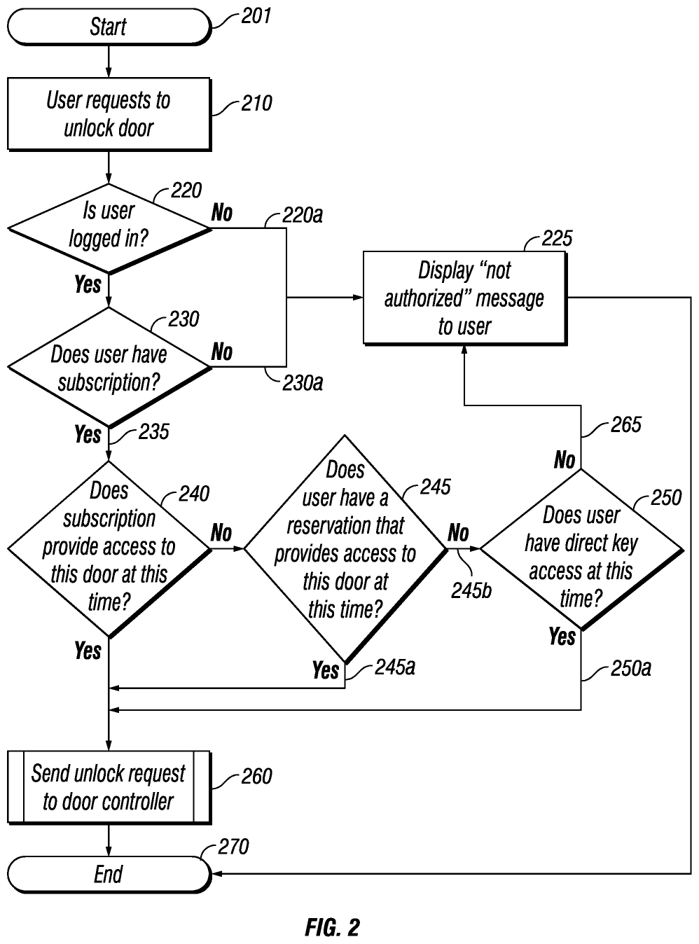

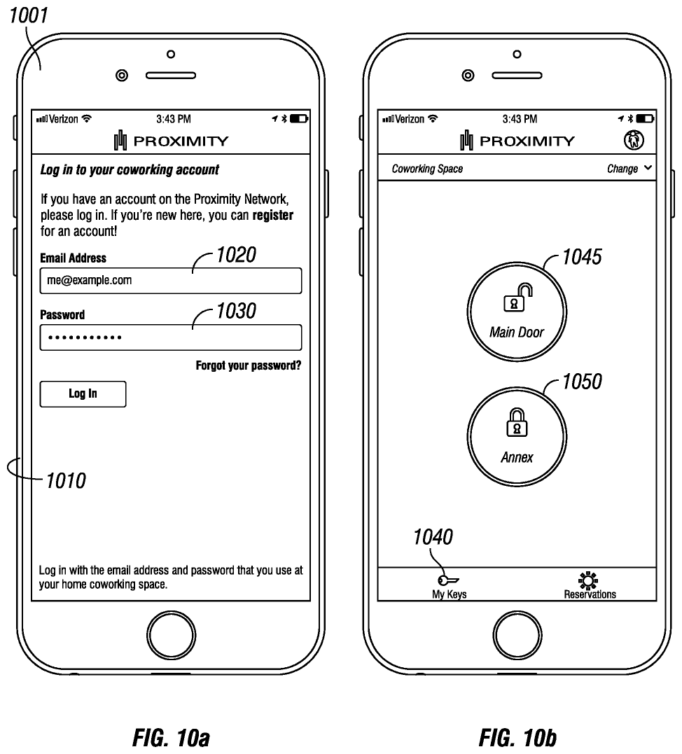

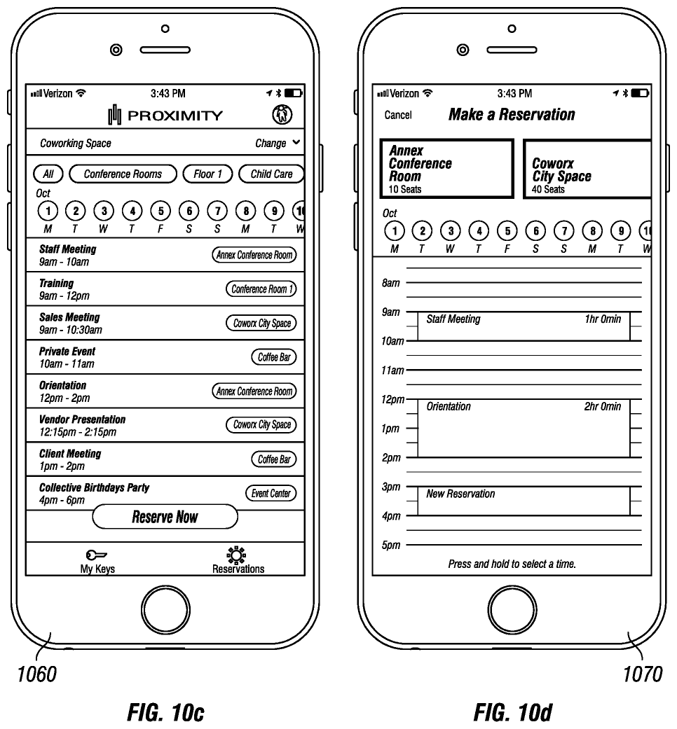

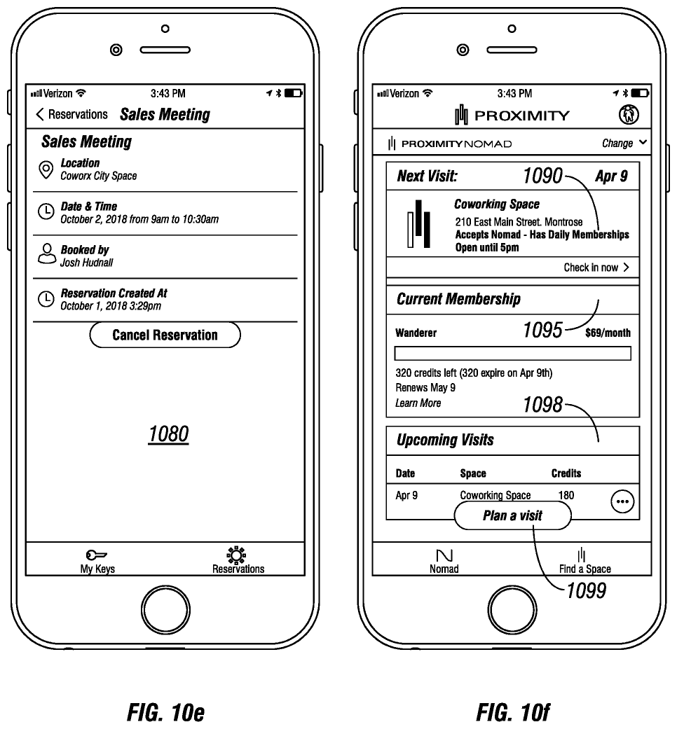

As depicted in FIG. 1, “Get Keys Flow,” in one possible embodiment, a user wishing to unlock a door via digital keys starts 101 by loading a screen in a mobile application or website requesting their “keys” where, after user authentication with user ID and password (see specifically user ID 1020 and password 1030 in FIG. 10a), user is then allowed to request a “key” (‘user requests keys’ 110) specifically designated to gain entry to a particular location site or subdivided area within said site. The system checks the authentication status of the user to determine if user is ‘logged in’ or not ‘logged in’ 115. If user is not logged in 116, the user is put through a standard login flow 118 before being returned to user keys screen (‘user requests keys’ 110) where the user's authentication status is checked again 119. Having a successfully authenticated user, the system will then check the user's subscriptions or subscription status to see if the user does indeed have an active subscription 120. If the user does not have an active subscription 125, the system will put the user into a subscription flow 130 where the user can be directed to purchase a subscription. Having a user with an active subscription 135, the system will then check to see if the user's subscription includes access to any keys for the space 138. If the subscription includes keys, those keys are added to the user's key list 140. The system then checks to see if the user has a reservation that provides access to a particular door during the reservation period (‘Does user have a reservation that provides access to this door at this time?) 145. If yes, the reservation provides access and a currently occurring reservation includes keys, those keys are added to the user's key list 147. The system subsequently checks to see if the user has been granted access to any keys directly by a space operator (‘Does user have direct key access at this time?) 150. If the user has directly granted keys, those keys are added to the user's key list 155. The system then looks at the combined list of keys 160 and determines (1) the set state of keys based on a door's schedule 165 for each key and (2) compares user's location with each key's geographic restrictions to remove unqualified keys 170. The system then determines if any keys remain (‘Does user's key list contain any keys?’) 175 which meets both the reservation and proximity requirements. If the user is close enough in proximity to the door to activate a key, those keys which are available are displayed 180 to user. If the user is not close enough, the key is removed from the combined list and the “no keys” message 185 is displayed. The system then looks at the combined list of keys and compares each key against the door's schedule and sets the state of each key as either locked or unlocked. If the resulting list of keys is not empty (i.e. the list has at least one key), the system then displays this key or these keys 180 to the user and a door or doors with a state of locked may be activated by the user to temporarily unlock the door for entry (See FIG. 2). If the list is empty, the system displays an error message to the user (End 190).

### Unlock Door Flow

As depicted in FIG. 2, “Unlock Door Flow,” in one possible embodiment, a user wishing to unlock a door via a digital key or keys starts 201, having loaded a list of keys as described in FIG. 1, “Get Keys Flow,” will make a request to unlock a door 210 corresponding to a key on the list of available keys 180 (See FIG. 1). Initially, the system checks the authentication status of the user to determine if user is ‘logged in’ or not ‘logged in’ 220. If they are not ‘logged in’ 220a, the system displays an error message (‘Display “not authorized” message to user) 225 to the user. Having a successfully authenticated user, the system checks to see if user has an active subscription 230. If the user does not have an active subscription at this space 230a, the system displays an error message (‘Display “not authorized” message to user’) 225 to the user. Having verified an active subscription 235, said user with an active subscription at this space, the system checks to see if the subscription provides access to use the requested key at the current time. If the subscription provides access to use the requested key at the current time 240, the system sends an authenticated unlock request to the door controller 260 via a wireless signal and server. If the subscription does not provide access to use the requested key at the current time, the system checks to see if the user has any reservations that are currently occurring 245 and that provide access to the requested key at this time 250. If the user has a reservation that provides access to the requested key at the current time 245a, the system sends an authenticated unlock request, by the above described means, to the door controller 260. If no reservation provides access to the requested key at this time 245b, the system checks to see if the user has been granted access to the requested key by the space operator 250. If the user has been granted direct access to the requested key 250s, the system sends an authenticated unlock request, via the above described means, to the door controller 260. If the user has not been granted direct access to the requested key, the system displays an error message 265 thus effectively ending the operation (End 270).

### Login Flow

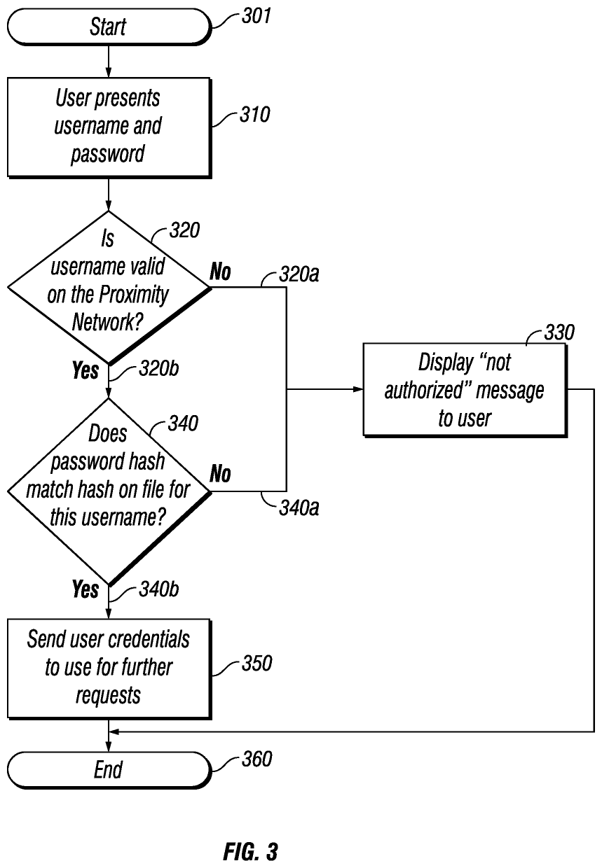

As depicted in FIG. 3, “Login Flow,” in one possible embodiment, a user entering the standard login flow (Start 301) will have the opportunity to provide a username and password (see username 1020 and password 1030 to match against user records in the system 310 as provided on a mobile computing device 1010 in FIG. 10). The system checks the username to see if it matches a user in the system 320. If the username does not match any user in the system 320a, the system displays an error message to the user 330. If the username matches a user in the system 320b, the system then checks to see if the cryptographically scrambled (hashed) version of the password the user has provided matches the cryptographically scrambled password stored on the record matching the username 340. If the password does not match the record 340a, the system displays an error message to the user 330. If the password does match the record 340b, the user is given a set of cryptographically secure credentials 350 that can be used in further requests to identify the user in the system, resulting in an end 360 to the present operation.

### Subscription Flow

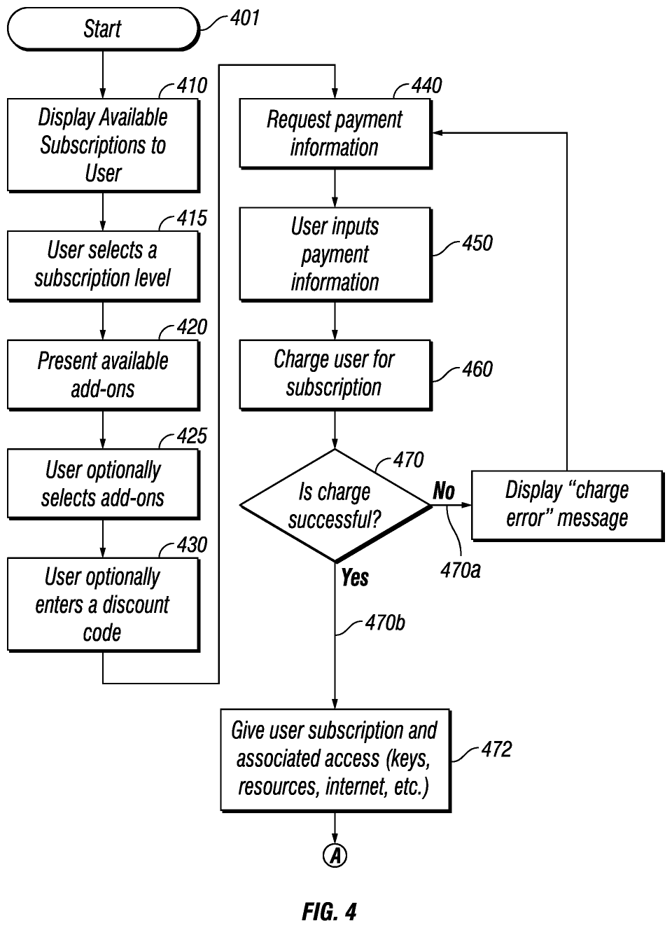

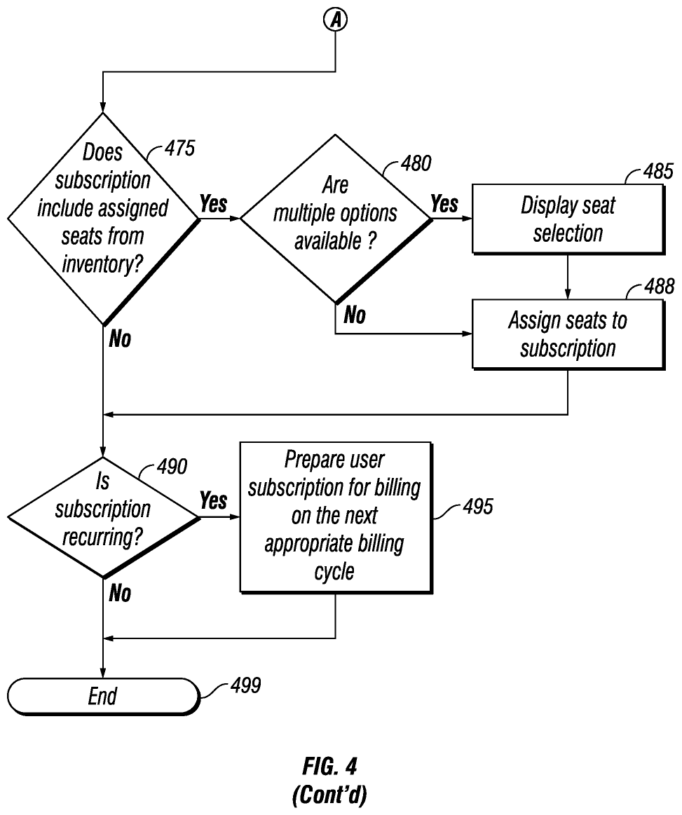

As depicted in FIG. 4, “Subscription Flow,” in one possible embodiment, a user wishing to purchase a subscription at a space would begin 401 by loading a screen listing all of the subscriptions that are available at that space 410. The user would then select a subscription level 415 desirable to them. The system will display any available add-ons 420 that can be included in the subscription. The user may optionally select one or more add-ons 425. Prior to finalizing the purchase, the user may enter a discount code 430 if one has been provided to them by the platform administrator or space provider. Once the user moves to the next step, the system will request payment information 440 from the user and the user will input that information 450 into a secure form. The system will attempt to charge 460 the user for the cost of the subscription plus any add-ons—minus any discount. If the charge is not successful 470a, the user is returned to step 440 where the system will ask for new payment information. If the charge is successful 470b the user is given the requested subscription and all rights, privileges, and access contained therein 472. A subscription may include an area, subdivisions of an areas, or one or more seats in a space 475. If the subscription includes seating, the system will present a seat selection or multiple seat selections 485 for the user to select from, or auto assign a seat if only one option is available 488. The system will then check whether the subscription is recurring 490 and set appropriate values on the subscription record to prepare for billing again on the next appropriate billing cycle 495. The operation will then end 499.

### Reservation Flow

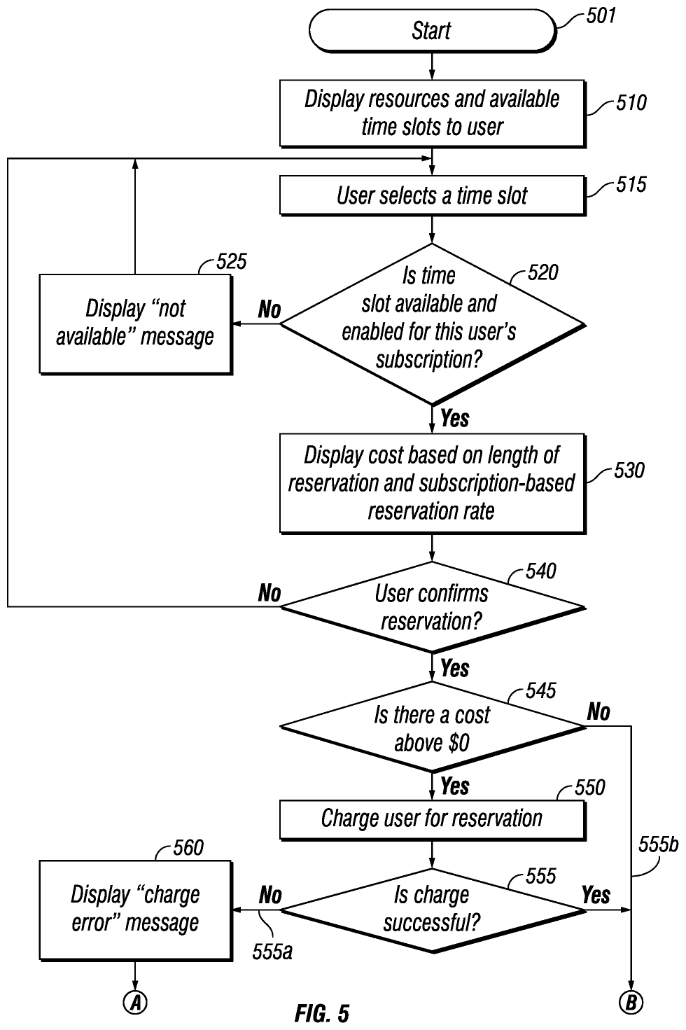

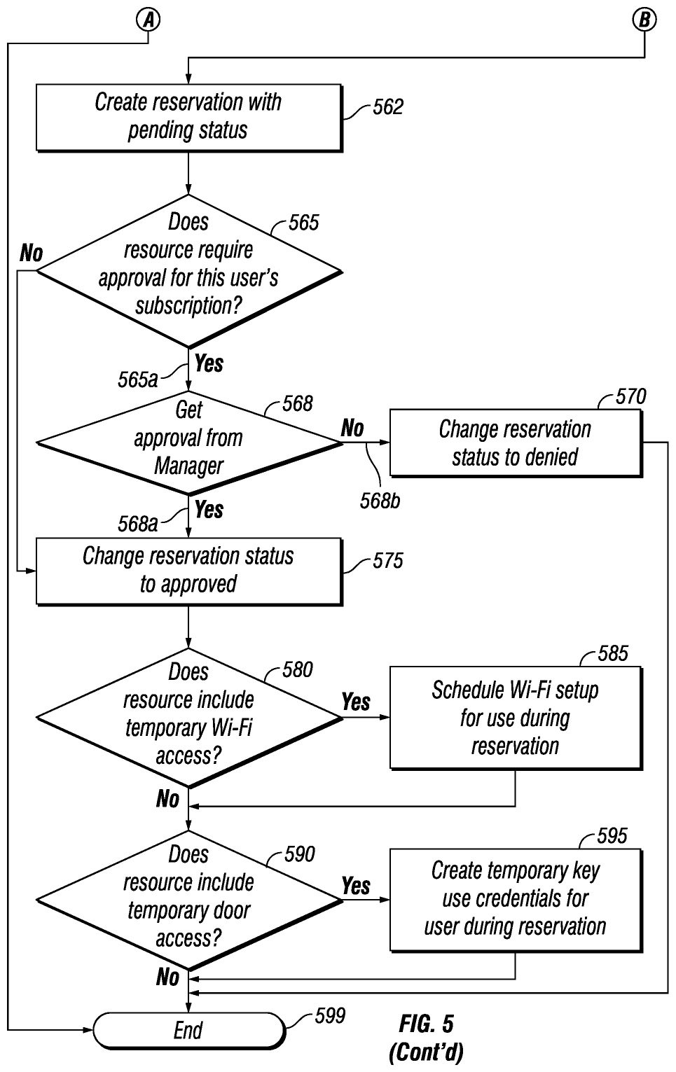

As depicted in FIG. 5, “Reservation Flow,” in one possible embodiment, a user wishing to schedule use of a resource would start 501 by loading a screen on which the system would display a list of resources and available reservation times by resource 510. The user would select a time slot 515 that user would like to reserve consisting of a location, area, a start time and end time. If the slot is already taken or is not available for the user's subscription 520, the system will display an error message (‘Display “not available message’) 525. If the slot is available, the system will display the cost based on the length of the reservation and the subscription level of the user 530. If the user confirms the reservation 540 the system will attempt to charge the user 550 if the cost is above $0.00 545. If the charge fails (i.e. the charge is unsuccessful) 555a, the system will display an error message to the user 560. If the charge is successful 555b (or if no charge is required), the system will create the reservation with a pending status 562. If the resource 565 requires approval for the user's subscription level 565a, the system will present the reservation to a manager 568 to be approved 568a or denied 568b. If the request is denied, the reservation is released and the status is changed to denied 570. If the reservation is approved or did not require approval, the reservation status is changed to “approved.” 575 If the resource includes temporary Wi-Fi® 580, the system will schedule a temporary Wi-Fi® network for the appropriate time 585. If the system includes temporary door access 590, the system will provide temporary access credentials for use during the reservation 595. Upon completion of the aforementioned, the operation will end 599.

### Internet Access Flow

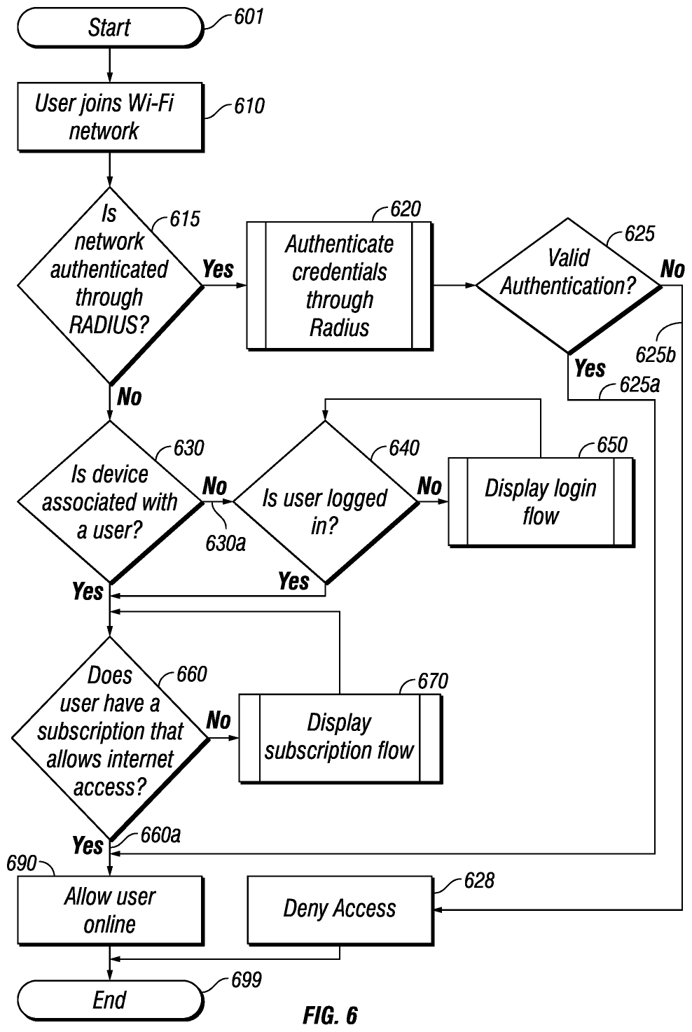

As depicted in FIG. 6, “Internet Access Flow,” in one possible embodiment, a user wishing to access the internet may start 601 by using a space's network would connect to the space's Wi-Fi® network using their device's networking capabilities through a user request 610. If the Wi-Fi® network is authenticated through Radius 802.11x (a standardized protocol for network-based authentication) 615, the space's networking gear will act as the authentication portal 620, authenticating user 625 and collecting the user's credentials and passing them on to the system for validation through the system's RADIUS authentication infrastructure protocol. If the credentials are valid 625a, the system will instruct the networking gear to allow the user online 690. If authentication is invalid, access will be denied 628. If the Wi-Fi® network is not authenticated through the RADIUS protocol 625b, the system will look at the device's MAC address (a unique identifier assigned to the device by the manufacturer) to see if a record of the device exists and is associated with a user in the system (not shown). If the device is not known or is not associated with a user 630, the system puts the user into the standard login flow (described in FIG. 3, “Login Flow”) 650 to determine if the user is ‘logged in’ 640. If the user declines to ‘log in’, access to the internet is denied (not shown). Once the user authenticates or if the user can be inferred from the device's MAC address, the system checks to see if the user has a subscription at the space that allows internet access 660. If the user does not have a subscription that provides internet access at the space, the system puts the user into the standard ‘Subscription Flow’ (described in FIG. 3, “Login Flow”) 670. If the user declines to purchase an appropriate subscription, access to the internet is denied (not shown). If the system determines that the user has or has purchased an appropriate subscription 660a, the system will instruct the space's networking gear to allow the user to access the internet 690 and end the present operation 699.

### Recurring Billing Flow

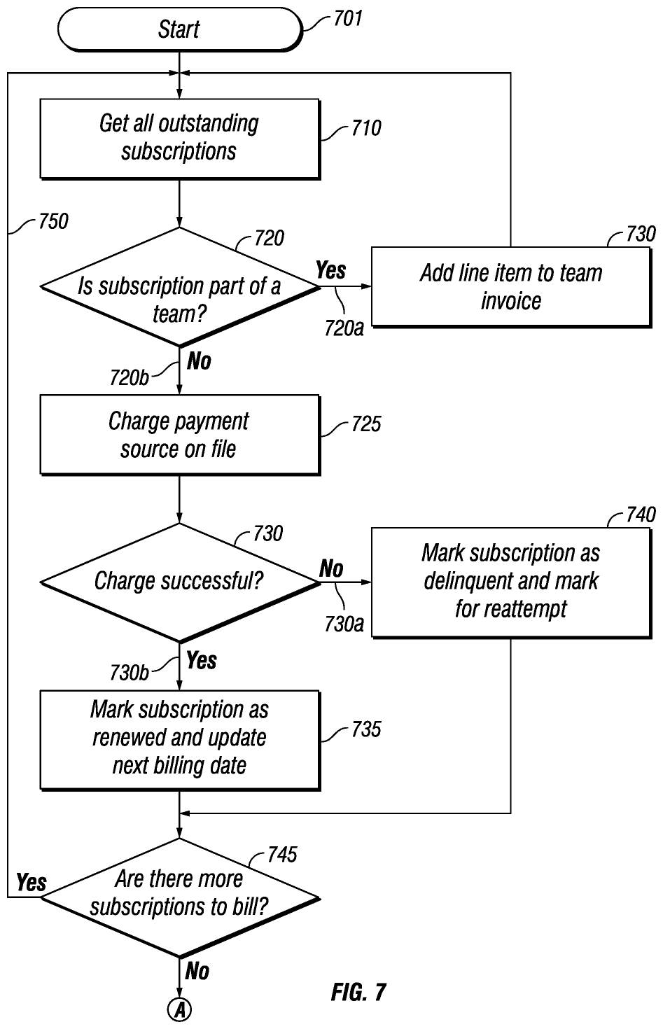

As depicted in FIG. 7, titled “Recurring Billing Flow,” in one possible embodiment, when the system runs a scheduled billing cycle, the system will load a set of all subscriptions 710 with due dates which have passed (i.e. which are currently due). For each subscription, the system will determine whether the subscription is part of a team 720 (described in the section labeled “Team”). If the subscription is part of a team 720a, it is added as a line item to an invoice 730 for that team to be billed in a further step (step 750). If the subscription is not part of a team 720b, the system attempts to charge the payment source on file 725. If the payment is unsuccessful 730a, the subscription is marked as delinquent and marked for reattempt according to a network-wide retry schedule 740. Delinquency may further incur surcharges. If the payment is successful 730b, the subscription is marked as renewed and the next billing date is updated according to the subscription level's recurrence settings 735. If there are more subscriptions with a due date in the past (i.e. currently due) to bill 745, this process repeats 750 until there are no more payments to process. The system then loads all of the team invoices generated in step 750 and for each invoice, attempts to charge the team's payment source on file 755. If the charge 760 is unsuccessful, the team and its subscriptions are marked as delinquent and marked for reattempt according to a network-wide retry schedule 765, which may incur late charges. If the charge is successful 760b, the team and its subscriptions are marked as renewed and the next billing date is updated according to a monthly schedule 770. If there are more team invoices to bill 780, this process repeats until there are no more invoices and billing 785. The system tracks all payments received, the spaces payments relate to, the fees applied to each space for platform use and/or payment processing and makes payouts to each space operator, manager or space owner automatically 790 and the operation ends 799.

### Network

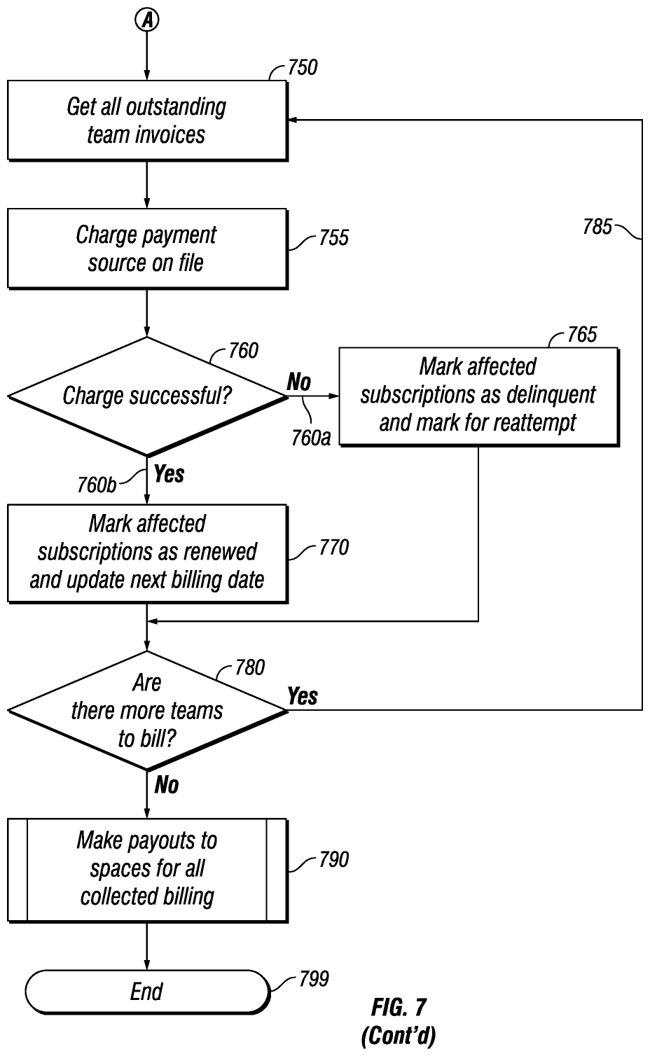

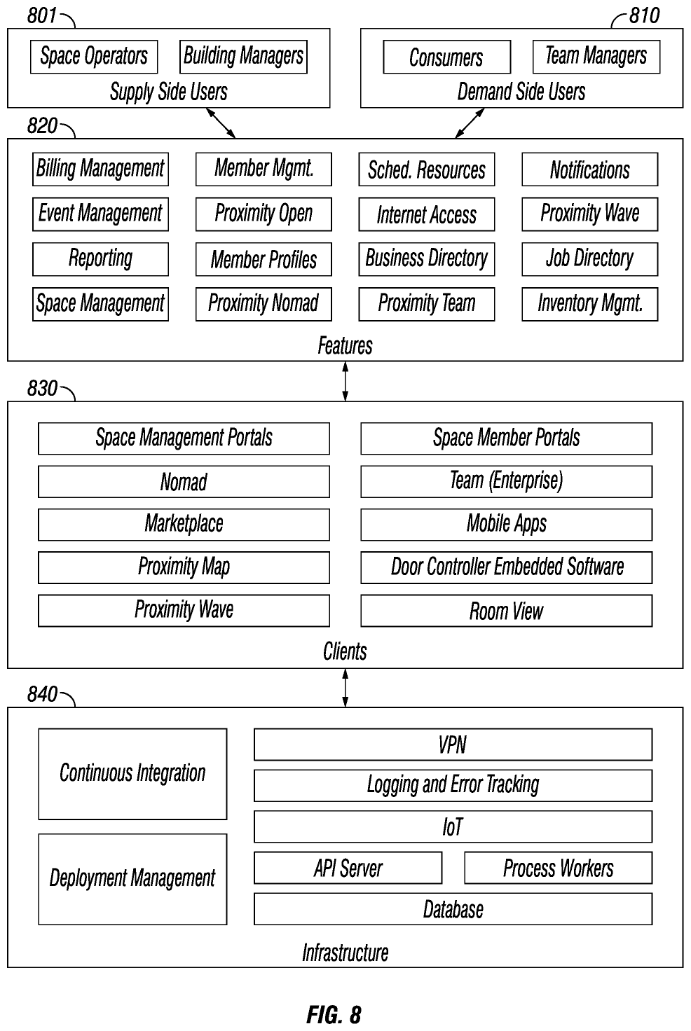

As depicted in FIG. 8, the present invention ‘Network’ is made up of supply side users (building managers and space operators) 801 and demand side users (consumers and team managers) 810 opting to participate with selected key features evidenced in one platform 820 encompassing a plurality of accessible features including, but not limited to billing management, event management, reporting, space management, member management, door access through “open, member profiles, international working access (via “Nomad”), scheduling resources, internet access, business directories, group billing (via “Team”), notifications, concierge services (via “Wave”), job directories and inventory management. Users (evidenced as clients) 830 themselves benefit through the use of the ease of use and seamless transition between and among features including having access to space management portals, national and international space networks, a marketplace for available spaces, location services, membership portals, group billing, website and mobile applications, door control and “Room View” for scheduling and reservation viewing. Finally, both operators and users benefit from the present invention's embedded infrastructure 840, namely, in which a group of servers perform various functions and tasks to enable the embodiments detailed and described in this application. One potential configuration of these servers utilizes a ‘pool’ of application servers that provide an API (application programming interface) with which clients can communicate, providing data, user input, action requests, etc. that the servers can then act on. API servers are generally responsible for receiving data, receiving user input, manipulating data, performing calculations and applying algorithms. API servers store data for short and long term retrieval in a database (operated on one or more servers) and retrieve that data for further processing and display to clients. Process workers are responsible for taking scheduled actions to keep data current and in the correct format and are responsible for long-running tasks such as image processing or email queueing. These various servers are connected to a pool of services responsible for logging and error tracking. These various servers communicate with the many clients either directly or via VPN (virtual private network) or IoT (Internet of Things) connections. This infrastructure is managed and tested in an environment controlled by deployment management applications and continuous integration applications.

### Door Controller Integration

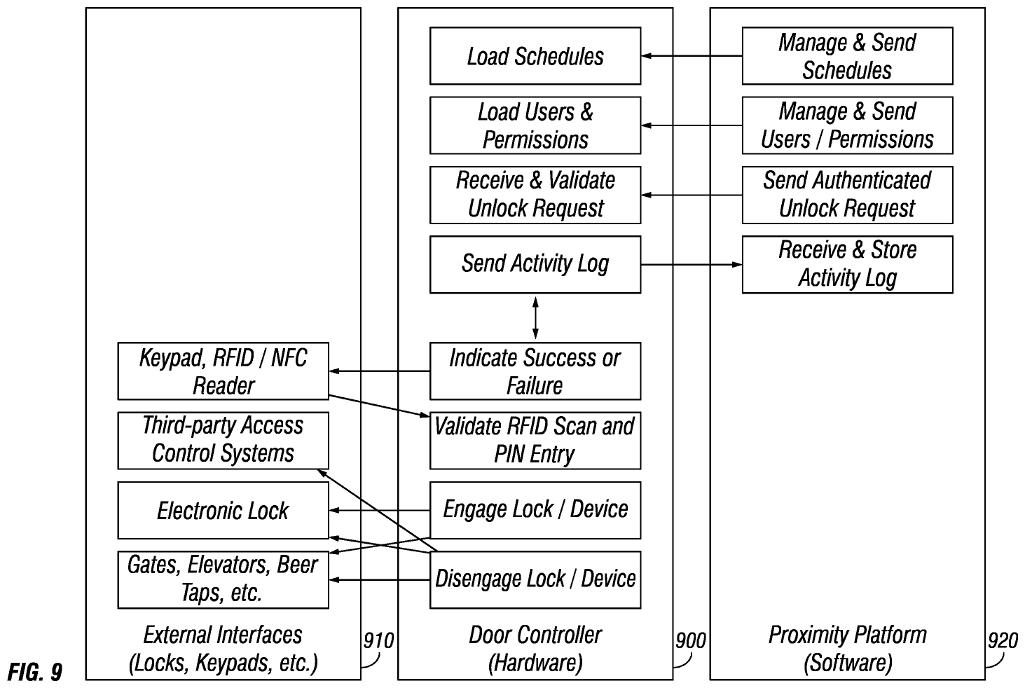

FIG. 9 evidences an overview of the interconnectivity and interdependence of hardware (device initiation and termination including locks and valves) 900, external access points, utilities and space resources activation (keypads, locks, dispensing devices, elevators, gates, garages etcetera) 910 and the software platform (including schedulers, authenticators, requestors and activity logs) 920 facilitating a coherent and consistent integration of features that offers a user interface-to-software-to-hardware solution for users to not only (1) browse, locate, purchase and access a space but also (2) take full advantage of the tangential amenities a space can offer.

### Mobile Application

By way of example, FIG. 10a illustrates a user interface wherein the user would be prompted by a mobile application 1001 on a mobile computing device 1010 to enter both a User ID 1020 and password 1030 (as described in detail in FIG. 3). FIG. 10b depicts a visual representation of ‘Get Keys Flow’ and ‘Unlock Door Flow’ flow of FIG. 2 wherein user has provided information sufficient to allow for mobile application authentication, has been provided a key 1040, as keys ‘Main Door’ 1045 and ‘Annex’ 1050, wherein the ‘Main Door’ 1045 is unlocked and the ‘Annex’ 1050 is locked. Further, FIG. 10c illustrates wherein schedules and calendar may be view and spaces reserved 1060, FIG. 10d depicts where spaces may be browsed and reservations may be made 1070, FIG. 10e is a subscreen of a scheduled reservation/event 1080 and 10f is a snapshot of user information regarding a next visit 1090, current membership status 1095, upcoming visits 1098 and the ability to create a future space visit 1099.

### Unified Billing and Payout Flow

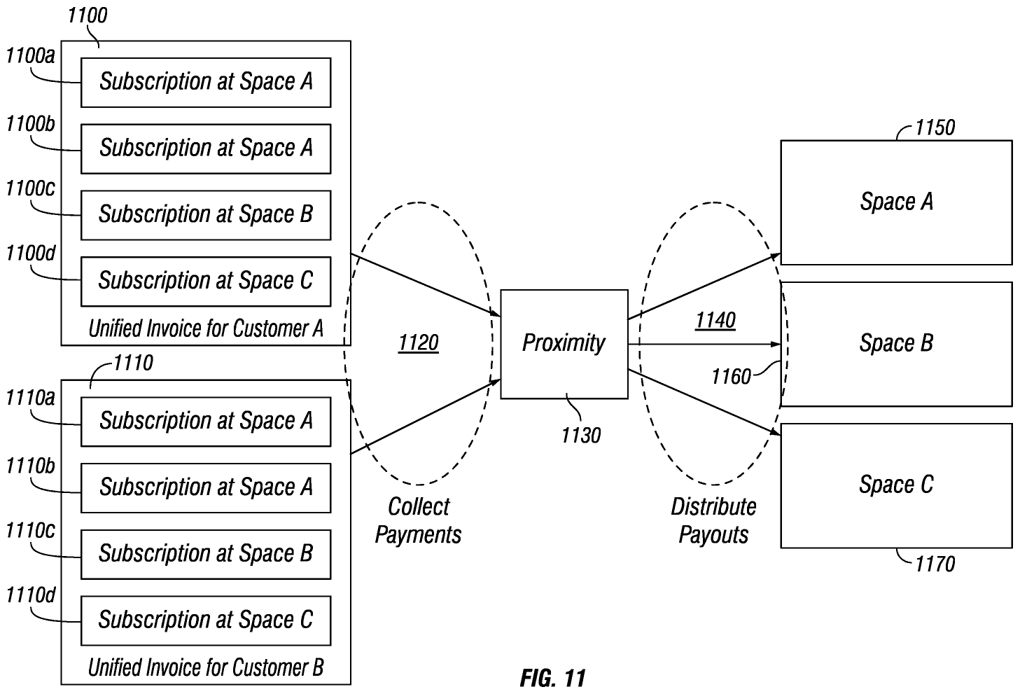

It may be desirable for one team, made up of two or more consumers, to purchase subscriptions, products, or services at two or more spaces, each operated by a different provider. In one possible embodiment, the invention can facilitate these transactions by allowing a manager of the team to search for subscriptions at any space in the network, add one or more memberships to any number of members of the team, paid for via a single payment source on a single invoice. As illustrated in FIG. 11, titled “Unified Billing and Payout Flow,” to facilitate this transaction, the system is capable of generating a unified invoices for a customer (Customer A in 1100 and Customer B in 1110) with line items for each subscription, space (Customer A: Space A 1100a, Space B 100b, Space C 1100c and Space D 1100d and Customer B: Space A 1110a, Space B 1110b, Space C 1110c and Space D 1110d), product, and/or service selected; tracking the provider for each line item on the invoice; collecting payments 1120 for the total of the line items on the invoice, including fees, discounts, add-ons and taxes, centrally 1130; and then distributing the funds 1140 to the accounts of each provider 1150, 1160, 1170 for the portion of the invoice, subdivided, that include subscriptions, products or services made available by that provider 1150, 1160 and 1170. A fee for billing services may be applied to outgoing payments by the platform operator prior to dispensing to operators, manager and space owners.

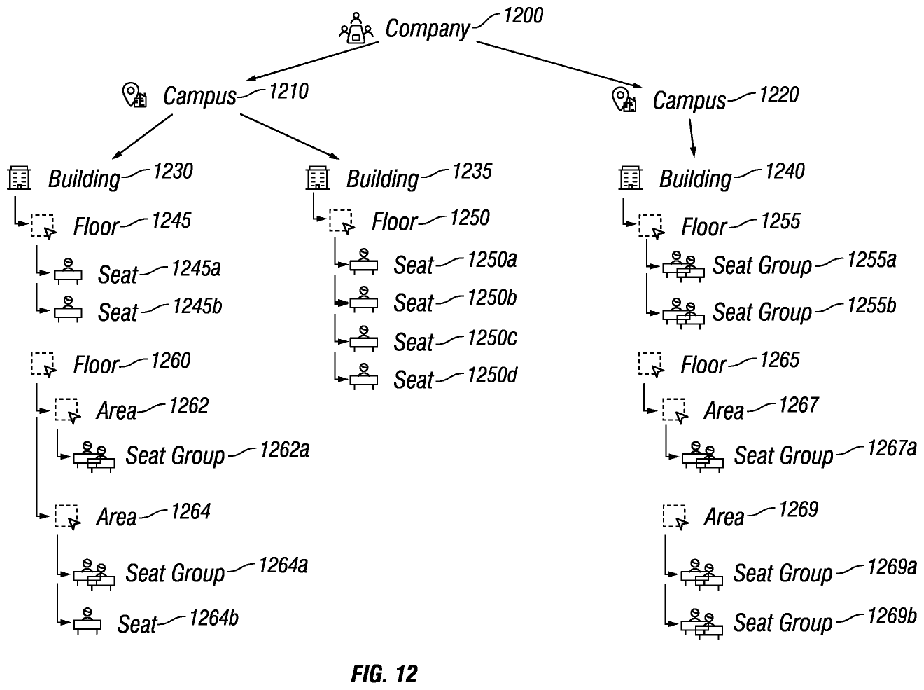

It may also be desirable for a space operator to create a structured, searchable representation of the reservable, purchasable space an operator makes available. In one preferred embodiment, the invention can facilitate this representation by allowing the operator to create a hierarchical inventory of the spaces they sell. FIG. 12, titled “Inventory Organization” depicts the hierarchy that can be used to organize and index of reservable spaces into a format that can be searched, reserved and purchased. A company 1200 with multiple campuses 1210, 1220, some having multiple buildings 1230, 1240, 1250, of which some are multi-floored 1245, 1250, 1255, 1260, 1265 with certain floors divided up into functional areas 1262, 1264, 1267, 1269, can catalog reservable space down to the seat groups 1255a, 1255b, 1262a, 1264a, 1267a, 1269a, 1269b down to individual seats 1245a, 1245b, 1250a, 1250b, 1250c, 1250d, and 1264b. Seats can be listed individually or as a group of seats 1255a, 1255b, 1262a, 1264a, 1267a, 1269a, 1269b, and a group of seats 1255a, 1255b, 1262a, 1264a, 1267a, 1269a, 1269b can be made available for individual reservation or made to be reserved as a collective whole. Additionally, seats 1245a, 1245b, 1250a, 1250b, 1250c, 1250d, and 1264b can be assigned or made available on a first come, first served basis (“hot seats”).

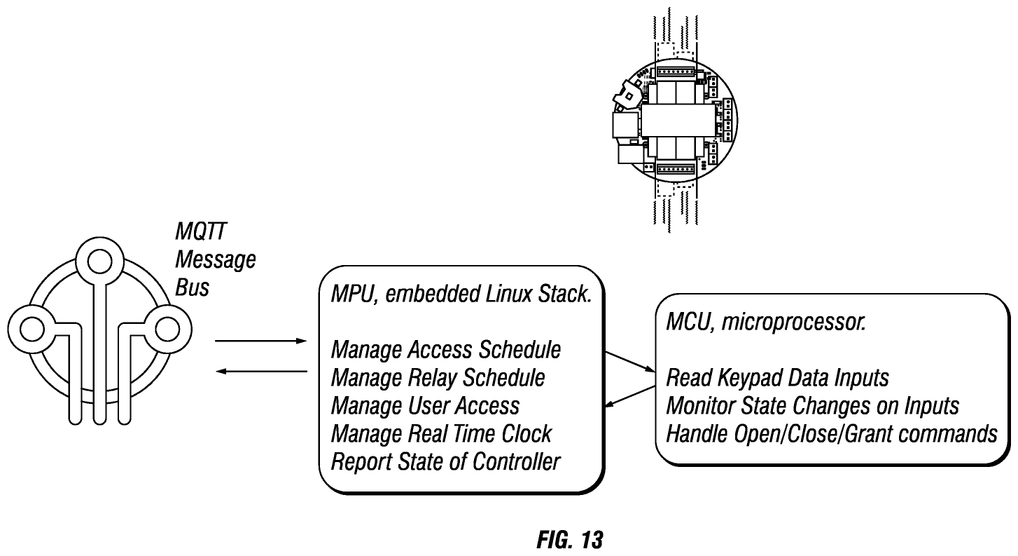

As depicted in FIG. 13, titled “Open Controller,” The Proximity Open Controller MPU (micro processing unit) runs an embedded Linux software stack. This application securely retrieves subscriber access schedules, relay channel schedules and user subscription lists from the Proximity IoT (Internet of Things) network. The MPU manages a real time clock to ensure subscriber access schedules and relay states are maintained during a power outage or internet connectivity issues. This application also reports the state of the ‘Open’ controller back to the system an IoT network. These reports can include a “heartbeat” with info about the current state of the controller, grant access requests, relay channel state changes, state changes on inputs (door position status sensors, etc.), and acknowledgment of successful subscriber access schedule, relay channel schedule and user subscription lists retrievals. This application contains logic required to determine if data received from the keypad matches conditions based on subscriber access schedules and user subscription lists to allow a grant access command to be sent to a specific MCU (microcontroller) in communication with a specific device. The Open Controller MCU reads keypad data inputs, monitors state changes on inputs and handles relay state change requests.

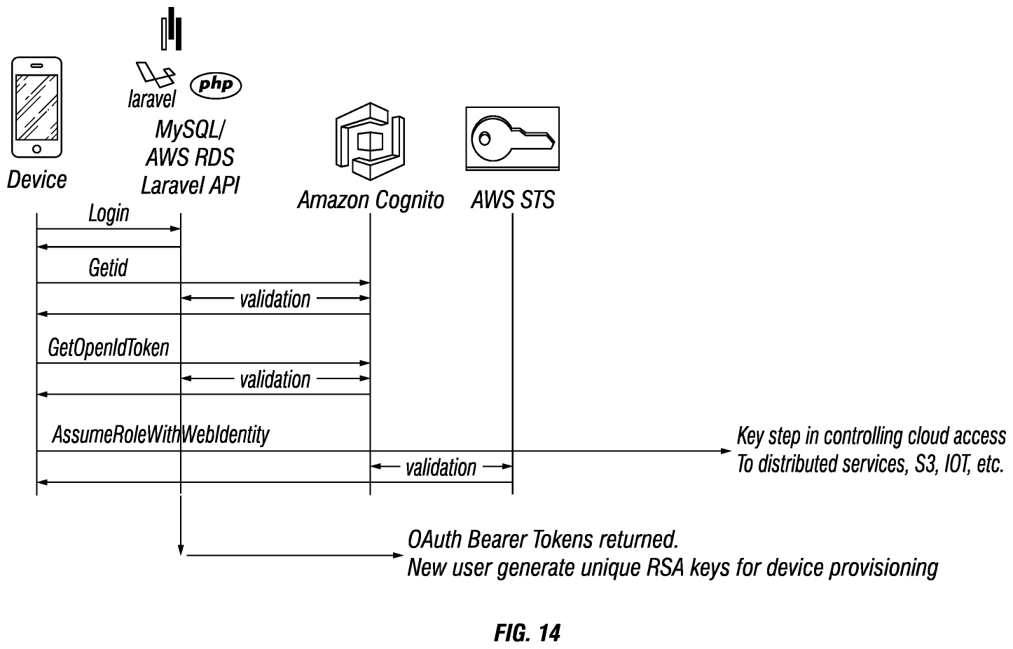

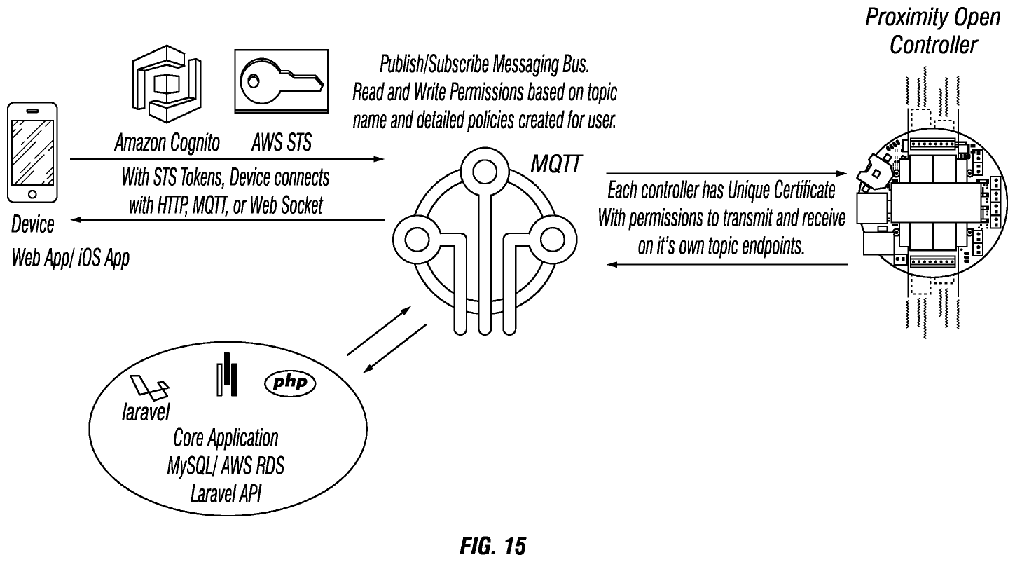

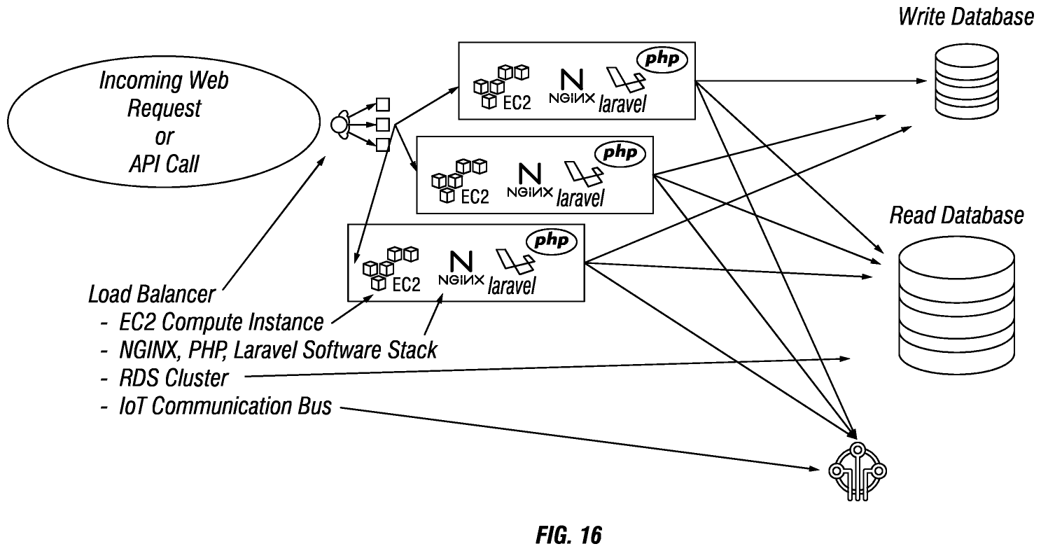

As depicted in FIG. 14, titled “Initial Authentication,” FIG. 15, titled “Authenticated User,” and FIG. 16, titled “Core Application Structure,” the core application receives a secure https (hypertext transfer protocol) grant access request from an authenticated user via the web application or mobile apps. The core application then determines if the requesting user has permission to unlock the door at the time of request (see ‘Unlock Door Flow’). If the core application determines the requesting user has access, a ‘grant access’ request is published to a secure topic on an IoT network. The Open Door controller is ‘listening’ to this topic and picks up the grant access request and sends the command to trigger the relay unlocking the door. When an access schedule, relay channel schedule or subscriber list is updated by an authenticated user via the internet web application or mobile applications the core application publishes those on a secure topic on an IoT network. The ‘Open Door’ controller is listening to this topic, picks up the changes and persists to local storage.

The particular embodiments disclosed are merely illustrative, which may be apparent to those having skill in the art and may be modified in diverse but equivalent manners. It is therefore contemplated that these particular embodiments may be altered and modified and that all such alterations are considered within the design and considerations of inventors of the present application. And while these illustrations are of a limited number set, it is clear that the invention itself is mutable to any number of arrangements, configurations and modifications without departing from the invention's spirit thereof.

We claim:

1. A system for integrating various search, location, reservation, scheduling, access and payment functions into one platform, comprising:
a space;
said space having a powered door lock or plurality of powered door locks, magnetic, strike or a combination thereof, for ingress, egress and access to said space;
a user;
said user desiring and requiring access to a space;
a space operator;
said operator desiring and requiring to lease a space;
a mobile software application, internet web application or a combination thereof;
said mobile software application or internet web application may be connected to door locks via a door lock controller and server connection wherein said mobile application and server may communicate with said door lock processor and said door lock processor may communicate with said mobile software application or internet web application, bidirectionally;
said communication may allow for locking, unlocking and lock state functions;
said mobile software application or internet web application having a user interface whereby said user may acquire a subscription to said mobile software application and gain access to said mobile application through membership and authentication;
said mobile software application or internet web application allowing a space operator to make available a space to a user;
said mobile software application or internet web application allowing said user to locate, rank, prefer and choose a purchasable space among a list of available spaces;
said mobile application or internet web application allowing said user to purchase and reserve a specific space or plurality of spaces at a specific time or specific times as a space reservation;
said mobile application or internet web application allowing a user to request a key or keys to said lock or plurality of locks after authentication;
said mobile application or internet web application, through communication to a server, capable of determining a set state of keys based on a door or plurality of doors schedule, a reservation or a plurality of reservations, a location or plurality of locations, user membership or memberships or a combination thereof;
said mobile application or internet web application capable of comparing said user location with each key's geographic restrictions and remove unqualified keys;
said mobile application or internet web application capable of determining if user is authorized to use any available keys for a particular location; and
said mobile application or internet web application displaying a key or plurality of keys available to user at a given location.

2. The system of claim 1 wherein said mobile application, internet web application or a combination thereof, may communicate authorization of admittance of a user to a space by other means including contacting the operator directly, via internet or wireless communication, and informing said operator of user's verification and authorization for space access.

3. The system of claim 1 wherein,
said user, after providing valid login information and verifying subscription, requests a key to unlock said lock or locks;
said mobile application, internet web application or combination thereof, after confirming subscription, verifies that subscription provides a key or keys providing access corresponding to said reservation and location; and
said user is then provided unlocked door access to an authorized space through mobile or internet application, through said server and to a receiving functional component of said lock or locks or through direct communication to space operator.

4. The system of claim 1, whereby:
mobile application or internet application may display, and user may select, subscriptions, including features, based on the needs and desires of user;
said mobile application or internet application requests payment information from user based on subscription level;
user inputs payment or accesses previously entered payment information;
mobile application effectuates payment, and upon successful completion, user is provided subscription verification, door keys, access to subscription level available space resources, amenities and space internet connections.

5. The system of claim 3, whereby user's subscription allows user to accomplish one or more of the following more effectively via said platform:
a. search space locations;
b. search space resources;
c. search space cost;
d. search space availability;
e. purchase space, through a reservation, at a designated time;
f. access a space through an effectuation of remotely, mobile or internet application assisted, space access; and
g. pay for a space reservation.

6. The system of claim 1 whereby a participating operator may use the current platform to accomplish one or more of the following:
a. advertise space locations;
b. advertise space resources;
c. advertise and convey space cost;
d. display space availability;
e. let space or areas within a space, through a reservation, at designated times;
f. approve reservations;
g. allow access to a space through approval through a remote mobile or internet application;
h. allow access to a space manually upon confirmation of a user's subscription;
i. accept payment for a space reservation;
j. monitor and control property use;
k. monitor and control resource use; and
l. monitor and control utilities use.

7. The system of claim 1 wherein a user may request a reservation and an operator may grant a reservable space whereby the platform may accomplish one or more of the following:
a. grant a temporary or permanent Wi-Fi access based on subscription; and
b. create a temporary key or keys' use credentials for user during reservation time.

8. The system of claim 1 whereby said platform may invoice a user or group of users, on a single or recurring basis, individually or as a group or team of users.

9. The system of claim 8 whereby said invoice may be modified by a set of parameters taking into consideration usage fees, cleaning fees and taxes and platform charges.

10. The system of claim 1 whereby a group of unassociated or associated operator controlled spaces may be grouped into a common marketplace of operators for locating, viewing, reviewing and purchasing of space by users.

11. The system of claim 1 whereby a user can choose to participate in a single transaction or multiple transactions.

12. The system of claim 1 wherein spaces may be divided and subdivided into companies, campuses, buildings, floors areas and seats as to allow reservations ranging from entire spaces down to individual seats.

13. A method of space management facilitating and granting an individual access to certain areas, through membership and credentialing, as well as, direct consumer billing, property manager scheduling and payment and collection of reimbursement receipts in a single platform comprising:
entering, by a user, credentialing information into a mobile device application or internet application;
receiving and verifying, by said mobile device or internet application, through a connected server, inputted information;
assigning a subscription status to said user;
verifying by said mobile device or internet application key or keys associated with said subscription;
verifying by a server via said mobile device or internet application that the subscription, and associated key or keys, corresponds to user, a reservation time and a location;
alternatively, confirming mobile device or internet application that user has direct access;
determining by said mobile device or internet application and server the state of a key or plurality of keys based on a door schedule;
comparing mobile device or internet application user's location with each key's geographic restrictions and removing unqualified keys; and
displaying to user qualified keys for space access based on location and geographic restrictions.

14. The method of claim 13 wherein individual access to a space is accomplished by the following;
requesting access, by the user, to a locked door or restricted area;
confirming by mobile device or internet application, via said server, the following:
(a) user's ‘logged in’ status, (b) user's subscription status, (c) key or keys availability in user's subscription status, (d) user's reservation status (e) user's location and user's direct key access; and
sending from mobile or internet application a command, from application to a server to the functional mechanical locking mechanism on a door, to open.

15. The method of claim 14 whereby a (a) internet access (b) physical access controlled by magnetic locks, electronic strikes, valves, machinery, gates, motors, (c) utilities thermostats, flow meters, circuits and other physical devices through the present platform may be controlled through the present application-server-functional mechanism to control resources on a scheduled or manually inputted schedule.

16. The method of claim 15 whereby spaces may be displayed for purchase by operators, users may search, research, locate and purchase spaces, users may be invoiced through said platform and operators may be paid through said platform.

17. The method of claim 15 whereby said platform functions by:
billing said users individually or by group;
paying said operators for purchasing space may be divided between and among various operators and distributable from users to operators based on space rates and usage, minus applicable fees and taxes and platform operator fees.

18. The method of claim 13 whereby said reservations may be made on a building, floor, area, group of seats to a per seat basis based on inventory.

19. A platform for space management and control, granting an individual access to certain areas, through membership and credentialing, as well as, direct consumer billing, property manager scheduling and payment and collection of reimbursement receipts allowing for:
user access through credentialing;
user use through subscription;
user viewing and reviewing of spaces and space locations;
user purchasing of said spaces and space locations;
user access to space;
user listing of profile;
platform listing of operators;
platform grouping of users;
platform coordination of events;
platform collection of fees from users;
platform paying of fees to operators;
platform deducting of usage fees;
platform calculation of taxes and fees for spaces;
platform allotment of a range of spaces from buildings to seats;
operator listing of spaces;
operator listing of resources;
operator control, regulation and maintenance of spaces; and
operator collection of proceeds.
